(19) United States
(12) Patent Application Publication
(10) Pub. No.: US 2026/0090492 A1
(43) Pub. Date: Apr. 2, 2026

(54) A SYSTEM FOR PRODUCING A SEED AND/OR FERTILIZER FILLED PLANT GROWTH MEDIUM POT, ROD, OR BAND, AND AN APPARATUS THEREFOR

(71) Applicant: ELLEPOT A/S, Esbjerg N (DK)

(72) Inventors: Thomas Lindberg Tranberg, Varde (DK); Peter Meldgaard Jacobsen, Esbjerg V (DK)

(21) Appl. No.: 19/111,413

(22) PCT Filed: Sep. 18, 2023
(86) PCT No.: PCT/EP2023/075580

§ 371 Date: Mar. 13, 2025

(30) Foreign Application Priority Data
Sep. 23, 2022 (DK) PA202200861

(51) Int. Cl. A01C 1/04; A01G 9/029; A01G 9/08; A01G 24/60

(52) U.S. Cl. CPC A01C 1/04; A01G 9/0299; A01G 9/085; A01G 24/60; A01C 2001/048

(57) ABSTRACT

A system for producing a seed and/or fertilizer filled plant growth medium pot, rod, or band is provided. The system includes a supporting means (adapted for receiving and supporting a plant growth medium pot, rod, or band), a feeding tube adapted to be in a retracted position or an extended position (for insertion into the growth medium), and a delivery unit (adapted for delivering a seed and/or a dosage of fertilizer through the feeding tube and into the growth medium). The feeding tube includes a cutting means, preferably a knife blade, mounted at the tip of the feeding tube. The cutting means is adapted for cutting into the plant growth medium pot, rod, or band, thereby facilitating the movement of the feeding tube into the plant growth medium pot, rod, or band.

### TECHNICAL FIELD OF THE INVENTION

The present invention relates to the production of growth medium pots, rods, or bands.

### BACKGROUND OF THE INVENTION

For the seed propagation of plants, it is well-known in the art to add the seed during a line production operation. The general problem with this process is to precisely position the seed on top of the growth medium of a growth medium pot, rod, or band. During subsequent operation steps, the seed also tends to displace from its original position.

EP1197137 discloses a method of growing two plants for the development of a composite or combined plant structure including leaves. The two plants are mingled together in a composite structure. The sowing of a first and second seed may be performed at the same time or with a delay between the two seeds, depending on their respective growth rates. Seeding into the growth medium is disclosed performed by means of an injector sowing device through a seed dispenser inserted into the growth medium.

### DESCRIPTION OF THE INVENTION

It is an object of the present invention to provide a system that overcome the above-mentioned problems.

A first aspect relates to an apparatus for producing a seed and/or fertilizer filled plant growth medium pot, rod, or band, comprising:
a supporting means adapted for receiving and supporting a plant growth medium pot, rod, or band;
a feeding tube with a tube lumen, said feeding tube adapted for being in a retracted position and in an extended position, wherein said extended position is for insertion into the growth medium of said plant growth medium pot, rod, or band;
a delivery unit adapted for delivering a seed and/or a dosage of fertilizer through said feeding tube and into said growth medium.

Hence, an apparatus may perform a process to produce the seed and/or fertilizer filled plant growth medium pot, rod, or band. The process comprises the steps of:

i) providing a plant growth medium pot, rod, or band; and
ii) inserting a feeding tube with a tip, e.g., a blunt or sharp ended tip, into the growth medium of said plant growth medium pot, rod, or band;
iii) delivering a seed and/or a dosage of fertilizer through said feeding tube and into said growth medium; and
iv) removing said feeding tube from said growth medium, thereby allowing said growth medium to close around said seed and/or dosage of fertilizer to produce a seed and/or fertilizer filled plant growth medium pot, rod, or band.

The inventors of the present invention utilize a feeding tube to precisely position the seed within the growth medium of the plant growth medium pot, rod, or band. Rather than seeding on top of the growth medium, the seed is secured in its position within the growth medium, preferably 1-20 mm below the surface, such as within the range of 2-18 mm, preferably within the range of 5-15 mm. The inventors have realized that this technique is also suitable for delivering a dosage of fertilizer to the growth medium.

In one or more embodiments, a seed and a dosage of fertilizer is delivered through the feeding tube at the same time, preferably formulated as a single unit, e.g., as a pellet.

In one or more embodiments, the dosage of fertilizer is delivered through the feeding tube as one or more pellets.

In one or more embodiments, the seed and/or dosage of fertilizer, during the insertion operation, is held on (preferably by the aid of suction through said feeding tube) or within the tip of the feeding tube.

In one or more embodiments, the seed and/or dosage of fertilizer held on or within the tip of the feeding tube is actively released therefrom, e.g., by the aid of blowing air through said feeding tube, or by a mechanical push mechanism, such as a piston.

The seed may in some embodiments be coated, thereby improving the ease of handling, and quality. Seed coating is the application of materials onto the surface of seeds, e.g., for the purpose of making the seeds' shape, size, weight, and surface more uniform, e.g., to make the seeds easier to plant and/or to apply active compounds that improve seed quality and protect the seed from biotic and abiotic stress. One example of coating is film coating that utilises a binder, which is often a polymer, as a fixative to adhere active compounds within the coating to the seed such as fungicides, insecticides, or bio-stimulants. Film coating reduces harmful dust from treated seeds as well as producing a smooth surface so that seeds flow easily through processing and sowing equipment, such as through the feeding tube. Another example of coating is pelleting, which process surrounds the seed, or a group of seeds, with a shell that increases the size and weight of the seed and ensures a smooth, uniform shape—typically a sphere or ovoid. Pelleting seeds improves their handling and planting efficiency. Pelleting can also incorporate active ingredients, such as fertilizer or biocides, with the benefit that the pellet composition protects the seed from contact with phytotoxic compounds and gives them a better start in the germination process.

In one or more embodiments, step i) comprises producing a continuous length of growth medium with a first side face, a second side face located opposite to said first side face, and a first end face, wherein step ii) comprises inserting said feeding tube into the continuous length of growth medium's first or second side face, and wherein the process further comprises the step of v) separating a part of the continuous length of growth medium comprising said seed and/or dosage of fertilizer to form a seed and/or fertilizer filled plant growth medium pot, rod, or band. The steps ii) to iv) may be repeated several times along the length of the continuous length of growth medium before step v) is performed. In some embodiments, the continuous length of growth medium is sequentially or continuously being forwarded below the feeding tube. Alternatively, the feeding tube is moved along the continuous length of growth medium.

In one or more embodiments, step i) comprises producing a continuous length of growth medium with a first side face, a second side face located opposite to said first side face, and a first end face, wherein step ii) comprises inserting said feeding tube into the continuous length of growth medium's first end face; and wherein the process further comprises the steps of v) separating a part of the continuous length of growth medium comprising said seed and/or dosage of fertilizer to form a seed and/or fertilizer filled plant growth medium pot, rod, or band, and a new first face of said continuous length of growth medium, and vi) repeating the steps ii) to v) one or more times.

The term “continuous length of growth medium” refers to the production of growth medium, which is made in a continuous line as e.g., disclosed in WO9203914, or by producing lengths of e.g., stone wool (see e.g., WO12172186) or other types of growth medium from, respectively, a block of stone wool or a block of another type of growth medium and sorting them end-by-end to form a continuously growing length of growth medium. The length of growth medium is thereafter cut into pieces of suitable size (height relative to the diameter), corresponding to the desired size of growth medium pots, rods, or bands.

The advantage of seeding and/or fertilizing before the separation of a part of the continuous length of growth medium is that there is much more control over the placement of the seed(s) in a larger mass and more freedom to control and handle the subsequently formed seed and/or fertilizer filled plant growth medium pot, rod, or band.

When placing one or more seeds and/or dosages of fertilizer within the end face (the free end) of the continuous length of growth medium, it is e.g., possible to produce seed filled plant growth medium pots of varying heights.

When placing one or more seeds and/or dosages of fertilizer within the first and/or second side face(s) of the continuous length of growth medium, it is e.g., possible to produce special seed or fertilizer filled plant growth medium pots, rods, or bands of varying lengths that are especially suitable for hydroponic production.

In general, depending on the type and use of the seed and/or fertilizer filled plant growth medium pot, rod, or band, the seed and/or fertilizer may be placed at different positions and/or in different patterns in the plant growth medium pot, rod, or band.

Alternatively, it is possible to seed and/or fertilize after the separation of a part of the continuous length of growth medium. One advantage of this procedure is that it is possible to place a seed and/or dosage of fertilizer at either both or one of the first or second end faces of a formed (i.e., separated, e.g., cut) pot, rod, or band during a movement towards a distributor unit.

Hence, in general, the seed and/or fertilizer filled plant growth medium pots, rods, or bands may be produced as standing versions (i.e., standing on an end face) or lying versions (i.e., lying on a side face, preferably on a side face that has not been seeded). In other embodiments, the growth medium rod or bad could be a gutter filled with growth medium. The plant growth medium pot could be a paper pot, e.g., a growth medium covered by a suitable paper. Such paper pots are well-known within the art, and may e.g., be produced by machinery from Ellepot A/S.

When the seed and/or fertilizer filled plant growth medium pots, rods, or bands is produced as lying versions, the length of the growth medium pot, rod, or band is preferably at least 0.5 meters. Shorter lengths of 0.1-0.4 meters, are contemplated by the present invention, but less preferred. Compared to a traditional growth medium pot, which have a bottom end and a top end, this type of growth medium rod is configured with a front end and a rear end as its length requires it to lie down, e.g., within the cavity of the hydroponic reservoir. If produced as a growth medium covered by a suitable paper, this configuration reduces the area of growth medium, which is not covered by the sheet material and thereby reduces the risk of growth medium clogging the hydroponic system's filters, pumps, and tubing recirculating the nutrient solution.

The length of the growth medium pot, rod, or band may preferably for hydroponic production be within the range of 0.5-20 meters, such as within the range of 1-18 meters, e.g. within the range of 2-16 meters, such as within the range of 3-14 meters, e.g. within the range of 4-15 meters, such as within the range of 5-14 meters, and even more preferably within the range of 5-10 meters.

In one or more embodiments, the process further comprises the steps of:
providing an elongated hydroponic reservoir with one or more spaces each adapted for receiving a seed and/or fertilizer filled plant growth medium pot, rod, or band; and
positioning said plant growth medium pot(s), rod(s), or band(s) within said space.

In one or more embodiments, the process comprises the steps of:
placing one or more seeds and/or dosages of fertilizer within said first and/or second side face(s) by performing steps ii)-iv);
separating a part of the continuous length of growth medium comprising one or more seeds and/or dosages of fertilizer to form a seed and/or fertilizer filled plant growth medium pot, rod, or band by performing step v); and
repeating said steps one or more times.

In one or more embodiments, the process comprises the steps of:
placing one or more seeds at multiple sites and at a predefined distance therebetween along the length of said first and/or second side face(s) by performing steps ii)-iv) multiple times. This embodiment e.g., enables the production of multiple plants in each seed filled plant growth medium pot, rod, or band. This could e.g., be advantageous for hydroponic production of e.g., lettuce. Furthermore, the same process allows for line production of different lengths of seed filled plant growth medium pots, rods, or bands in the same run.

In one or more embodiments, the step i) comprises:
separating a part of a continuous length of growth medium to form a plant growth medium pot, rod, or band, each with a first side face, a second side face located opposite to said first side face, a first end face, and a second end face.

A second aspect relates to a seed and/or fertilizer filled plant growth medium pot, rod, or band produced by the process according to the present invention.

In one or more embodiments, the supporting means comprises an opening or a guide channel adapted for receiving a part of the feeding tube in said feeding tube's extended position.

In one or more embodiments, the supporting means is configured as a clamp adapted for being in a closed position and in an open position. When in its closed position, while supporting a plant growth medium pot, rod, or band, it secures that the seed and/or dosage of fertilizer may be precisely positioned in the growth medium. In the closed position it is preferably adapted for preventing a plant growth medium pot, rod, or band to lose its overall shape during the insertion of the feeding tube. Preferably, the clamp comprises an opening or a guide channel adapted for receiving a part of the feeding tube in said feeding tube's extended position. In its open position, it allows the plant growth medium pot, rod, or band to be moved forward or away from the clamp.

In one or more embodiments, the feeding tube is adapted for being in a closed configuration adapted for holding a seed and/or a dosage of fertilizer within the tube lumen, and in an open configuration adapted for allowing said seed and/or a dosage of fertilizer to escape from said tube lumen.

In one or more embodiments, the feeding tube lumen is defined by a front wall part and a rear wall part. Preferably, the front wall part comprises a knife blade (i.e., a cutting means) adapted for cutting into the plant growth medium pot, rod, or band, thereby facilitating the movement of the feeding tube into the plant growth medium rod. This embodiment is particularly useful when the plant growth medium pot, rod, or band comprises a paper lining. In such a situation, the paper may be cut as the feeding tube is inserted therethrough. In one or more embodiments, the rear wall part is resiliently tiltable relative to the front wall part and is blocking the lower end of the lumen in the lumen's closed configuration. Preferably, a spring unit is adapted for forcing the rear wall part to be positioned such that it is blocking the lower end of the lumen. The front wall part is preferably operably connected to the rear wall part.

In some embodiments, the front wall part is configured to force the lumen into its open configuration, e.g., by counteracting, if present, the spring unit forcing the rear wall part to be positioned such that it is blocking the lower end of the lumen.

In a preferred embodiment, the feeding tube comprises a cutting means, preferably a knife blade, mounted at the tip of said feeding tube, said cutting means adapted for cutting into said plant growth medium pot, rod, or band, thereby facilitating the movement of said feeding tube into said plant growth medium pot, rod, or band.

In one or more embodiments, the system further comprises:
an apparatus adapted for separating a part of the continuous length of growth medium comprising one or more seeds, thereby forming a seed filled plant growth medium pot, rod, or band.

In one or more embodiments, the delivery unit is a drum seeder. A drum seeder is well-known with the art. Alternatively, the delivery unit is a needle seeder.

In one or more embodiments, the system further comprises:
an apparatus adapted for producing a continuous length of growth medium with a first side face, a second side face located opposite to said first side face, and a first end face, wherein the feeding tube is adapted for being inserted into the continuous length of growth medium's first or second side face; and
an apparatus, such as a cutting apparatus, adapted for separating a part of the continuous length of growth medium comprising said seed and/or dosage of fertilizer to form a seed and/or fertilizer filled plant growth medium pot, rod, or band.

The apparatus adapted for producing a continuous length of growth medium may be as disclosed in WO1992003914 or WO19011742, hereby incorporated by reference. In some embodiments, the main difference is that the length of the rod may be substantially longer than the traditionally produced pot. In this case, a fewer number of separations (e.g., cuts) per time period is obviously needed.

The apparatus adapted for separating a part of the continuous length of growth medium may e.g., comprise a knife, a saw, a hotwire, or the like, preferably configured to be reciprocating. Such means are also described in WO1992003914 and WO19011742.

In one or more embodiments, the system further comprises:
a distributor unit adapted for positioning said seed and/or fertilizer filled plant growth medium pot(s), rod(s), or band(s) into an elongated hydroponic reservoir.

In one or more embodiments, the system further comprises:
a conveyor system adapted for transporting an elongated hydroponic reservoir through said distributor unit.

In one or more embodiments, the system further comprises:
a distributor unit adapted for positioning said seed and/or fertilizer filled plant growth medium pot(s), rod(s), or band(s) into an elongated hydroponic reservoir, or into a propagation tray, or into a storage or transport tray, or onto a storage or transport reel, or the like.

The distributor unit may in some embodiments be of any type known within the art being configured for distributing, and optionally also incorporating the apparatus adapted for producing a continuous length of growth medium, optionally in the form of growth medium held in a water and air permeable sheet material. Suitable types of distributor units may be as disclosed in WO2017216146, WO2017216145, or WO 19001944, hereby incorporated by reference.

In one or more embodiments, the elongated hydroponic reservoir is a tube, pipe, or gutter. The length of the elongated hydroponic reservoir may vary, but is preferably at least 2 meters long, such as within the range of 2-50 meters, e.g. at least 3 meters, such as within the range of 3-45 meters, e.g. at least 4 meters, such as within the range of 4-40 meters, e.g. at least 5 meters, such as within the range of 5-35 meters, e.g. at least 6 meters, such as within the range of 6-30 meters, e.g. at least 7 meters, such as within the range of 7-25 meters, e.g. at least 8 meters, such as within the range of 8-20 meters, e.g. at least 9 meters, such as within the range of 9-15 meters, e.g. at least 10 meters.

The distributor unit may in some embodiments e.g., comprise:
a plurality of distributor elements configured to move between a loading position and an unloading position; each distributor element comprising an open-ended channel or cavity adapted for receiving a whole number of seed filled plant growth medium pots; wherein the distributor elements, in a loading position, are positioned relatively to each other such that their open-ended channels or cavities are disposed in continuation to each other to form a receiving unit with an open-ended channel or cavity adapted for receiving a single length of seed filled plant growth medium pots; and wherein the distributor elements, when in an unloading position, are rotated, relative to their loading position, such that their open-ended channels or cavities are disposed parallel relative to each other. Such a type of distributor unit may also be configured to prepare a separated plant growth medium pot to be seeded and/or fertilized, where the seed and/or dosage of fertilizer is placed within the growth medium (i.e., the feeding tube is positioned within the growth medium and retracted again) when the distributor element is in its unloading position. Thereby, the seeding and/or fertilizing and unloading operations are performed simultaneously or at least sequentially. The distributor unit may further comprise a piston unit adapted for entering the open-ended channel or cavity of a distributor element when in the unloading position, thereby releasing the seed filled plant growth medium pot therefrom. In some embodiments, the feeding tube also functions as a piston unit. This configuration secures that the plant growth medium pot leaves the open-ended channel or cavity at the right time. In this way, the feeding tube has a dual role as part of both a seed and/or fertilizer delivery unit and a distributor unit.

Alternatively, the distributor unit may be configured as a rod or band guide adapted for directing the seed filled plant growth medium rod(s), or band(s) into an elongated hydroponic reservoir, or into a propagation tray, or into a storage or transport tray, or onto a storage or transport reel, or the like. The rod or band guide may be configured with openings adapted for allowing the feeding tube to operate through the rod or band guide to place one or more seeds along the length of the plant growth medium rod(s), or band(s) passing therethrough.

In one or more embodiments, the above-mentioned system(s) further comprises a conveyor system adapted for transporting an elongated hydroponic reservoir through said distributor unit.

The feeding tube and the delivery unit may be integrated into the distributor unit, e.g., thereby allowing the seed and/or dosage of fertilizer positioning process and the distribution process to be performed simultaneously.

In one or more embodiments, the system is further adapted for delivering a seed and a dosage of fertilizer through the feeding tube at the same time, preferably formulated as a single unit, e.g., as a pellet.

In one or more embodiments, the system is further adapted for delivering a dosage of fertilizer through the feeding tube as one or more pellets.

In one or more embodiments, the seed and/or dosage of fertilizer, during the insertion operation, is held on or within the tip of the feeding tube.

In one or more embodiments, the seed and/or dosage of fertilizer held on or within the tip of the feeding tube is actively released therefrom, e.g., by the aid of blowing air through said feeding tube, or by a mechanical push mechanism, such as a piston.

As used in the specification and the appended claims, the singular forms “a”, “an”, and “the” include plural referents unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about”, it will be understood that the particular value forms another embodiment.

It should be noted that embodiments and features described in the context of one of the aspects of the present invention also apply to the other aspects of the invention.

### BRIEF DESCRIPTION OF THE FIGURES

FIG. 1 shows a perspective view of a system for line production of seed and/or fertilizer filled plant growth medium pots, rods, or bands according to various embodiments of the present invention.

FIGS. 2A-C show examples of a continuous length of growth medium as well as a plant growth medium rod/pot.

FIGS. 3-6 show views of an exemplary process sequence of an operating feeding tube and delivery unit in accordance with various embodiments of the invention.

### DETAILED EMBODIMENTS OF THE INVENTION

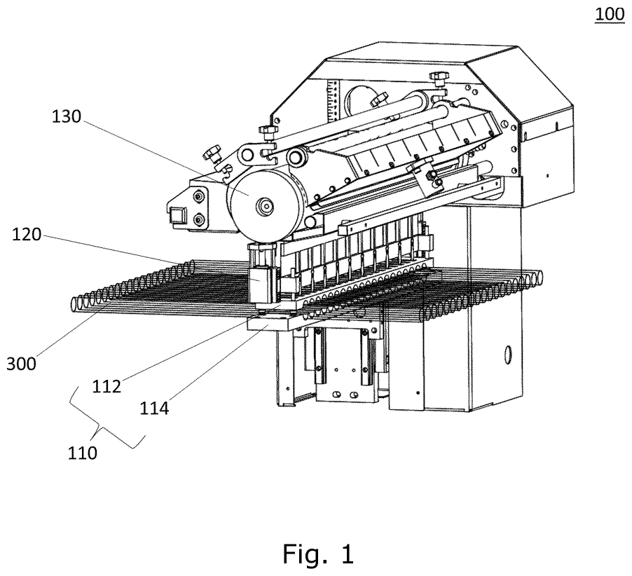

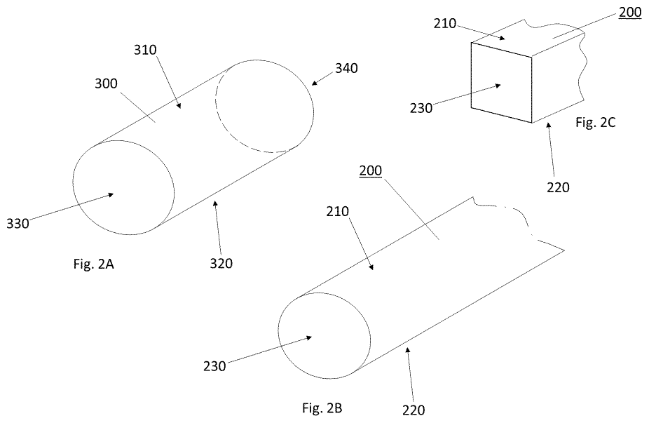

FIG. 1 shows a perspective view of a system 100 for line production of seed and/or fertilizer filled plant growth medium pots, rods 300, or bands according to various embodiments of the present invention. The system 100 comprises a supporting means 110 adapted for receiving and supporting a plant growth medium rod/pot 300 (see FIG. 2A) at a specific position along its length, or alternatively (not shown) a continuous length of growth medium 200 (see also FIG. 2B) at a specific position along its length. One or more conveyor units (not shown) may be present to support the remaining part of the plant growth medium rod 300, and for moving the plant growth medium rod 300 from left to right, or vice versa. The supporting means 110 is here configured as a sandwich clamp, but could have many other configurations, such as elongate guide bars positioned along the length of the plant growth medium rod 300, or individual pistons adapted for supporting the plant growth medium rod 300 in their extended position and releasing their support in their retracted position. The advantage of the sandwich clamp configuration is that the overall shape is supported. The sandwich clamp comprises a first clamp part 112, and a second clamp part 114. The first clamp part 112 is configured to be in a retracted position and in an extended position relative to the plant growth medium rod 300, and/or relative to the second clamp part 114, thereby being able to support the plant growth medium rod 300 in its extended position and releasing its support in the retracted position. In some embodiments, both clamp parts could be configured to be in a retracted position and in an extended position relative to each other. The shown supporting means 110 (and hence, the entire system) is adapted for supporting twenty plant growth medium rods arranged in parallel at the same time but could be built to only handle a single plant growth medium rod or multiple (e.g., 2-100 growth medium rods) plant growth medium rods, depending on the need for capacity.

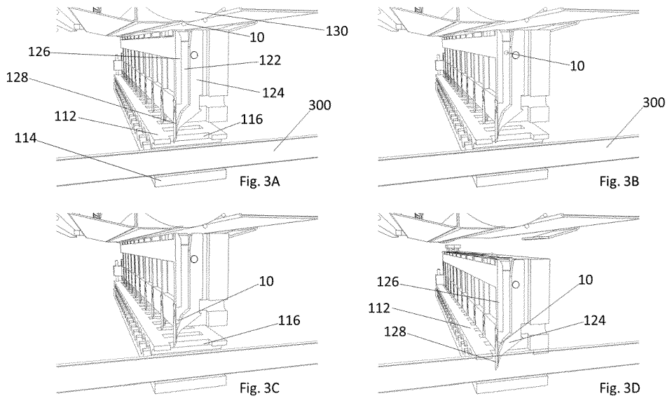

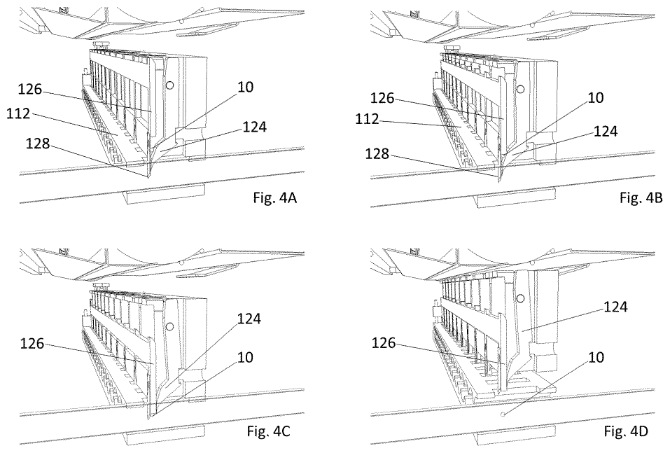

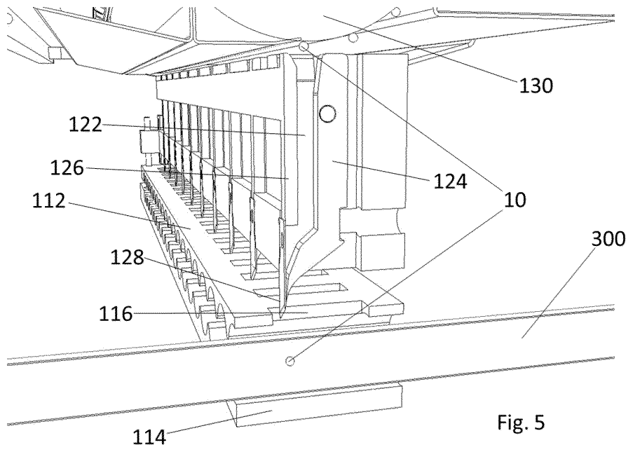

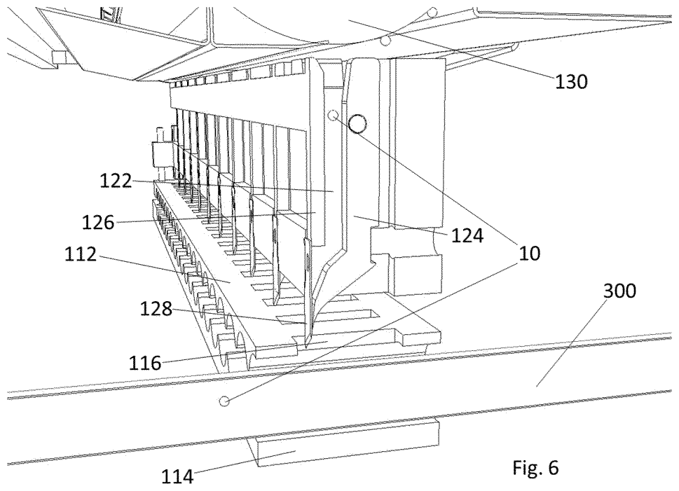

The system 100 also comprises a feeding tube 120, here twenty feeding tubes built together to one unit, and a delivery unit 130 adapted for delivering a seed and/or a dosage of fertilizer through said feeding tube 120, i.e., through each of the twenty feeding tubes. In the following, only one feeding tube will be mentioned when explaining the function as it is the same process that all feeding tubes undergo. As previously said, the system could be built for one or multiple plant growth medium rods. FIGS. 3-6 show an exemplary process sequence of an operating feeding tube 120 and delivery unit 130. In FIG. 3A, the system is ready for a new operation sequence, which sequence is to deliver a fertilizer coated seed 10 into the growth medium of the plant growth medium rod 300. The same operation sequence could be used to deliver e.g., a seed, or a fertilizer pellet into the growth medium of the plant growth medium rod 300. The delivery unit 130 (here a drum seeder, more particularly a rotary drum seeder), has positioned a pellet of seed and fertilizer 10 above the upper open end of the feeding tube's lumen 122 (the opposite lower end of the lumen 122 is closed in this configuration). The feeding tube is adapted for being in a closed configuration (i.e., the lower end of the lumen 122 is closed) adapted for holding a pellet of seed and fertilizer 10 within the tube lumen 122, and in an open configuration (i.e., the lower end of the lumen 122 is open) adapted for allowing the pellet of seed and fertilizer 10 to escape from said tube lumen 122. The lumen 122 is defined by a front wall part 126 and a rear wall part 124, both with important functions. The front wall part 126 comprises a knife blade 128 (i.e., cutting means) adapted for cutting into the plant growth medium rod 300, thereby facilitating the movement of the feeding tube 120 into the plant growth medium rod 300. The rear wall part 124 is resiliently tiltable relative to the front wall part 126 and is blocking the lower end of the lumen 122 in the lumen's closed configuration as is the case in all FIGS. 3A-D. Here, a spring (not shown) is forcing the rear wall part 124 to be positioned such that it is blocking the lower end of the lumen 122. In FIG. 3B, the pellet of seed and fertilizer 10 has entered the lumen 122, and in FIG. 3C, the pellet of seed and fertilizer 10 is resting in a position between the front wall part 126 and the rear wall part 124. In FIG. 3D, the first clamp part 112 if forced into its extended position by the feeding tube 120 that is moved downward, thereby fixating a part of the plant growth medium rod 300. The lower part of the rear wall part 124 and the lower part of the front wall part 126, including the knife blade 128, is at the same time moved into a guide channel 116 in the first clamp part 112 and into the growth medium of the fixed part of the plant growth medium rod 300. For comparison with FIGS. 4B-D, FIG. 4A is the same as FIG. 3D. The front wall part 126 is operably connected to the rear wall part 124, thereby being able to counteract the spring forcing the rear wall part 124 to be positioned such that it is blocking the lower end of the lumen 122. In FIGS. 4B-C, the front wall part 126 is separately moved further downwards, thereby pushing on the lower part of the rear wall part 124, resulting in the rear wall part 124 tilting away from the lower end of the lumen, which is thereby opened to allow the pellet of seed and fertilizer 10 to escape therefrom. In FIG. 4D, the entire feeding tube 120 is lifted back into place in its retracted position relative to the delivery unit 130 while the front wall part is still pushing on the lower part of the rear wall part 124. In this way, it is avoided that the pellet of seed and fertilizer 10 is sucked back into the tube lumen 122. Furthermore, the first clamp part 112 is moved back into its retracted position, releasing its grip on the plant growth medium rod 300. In FIG. 5, the front wall part 126 is separately moved further upwards (to its retracted position), thereby removing the pressure on the lower part of the rear wall part 124, resulting in the rear wall part 124 tilting back to block the lower end of the lumen 122. At the same time, the delivery unit 130 positions a new pellet of seed and fertilizer 10 above the upper open end of the feeding tube's lumen 122. In FIG. 6, the plant growth medium rod 300 has been forwarded a little to the left, thereby preparing a new part for seeding. The new pellet of seed and fertilizer 10 has been dropped into the tube lumen 122 and the entire process sequence is repeated a number of times until the plant growth medium rod 300 is seeded with the desired number of pellets with seed and fertilizer.

FIGS. 2B-C show examples of a continuous length of growth medium 200 with a first end face (only the free end with the end face is shown). The continuous length of growth medium 200 is embodied as a square rod in FIG. 2C and a cylindrical rod in FIG. 2B. Both rods are shown with a first side face 210, a second side face 220 located opposite to the first side face 210, and a first end face 230. The squared rod, obviously, has two further side faces.

FIG. 2A shows an example of a cylindrical growth medium rod 300 with first 330 and second 340 end faces and cut from a continuous length of growth medium 200 as shown in FIG. 2B.

### REFERENCES

10 Pellet of seed and fertilizer
100 System
110 Supporting means
112 First clamp part
114 Second clamp part
116 Guide channel
120 Feeding tube
122 Lumen
124 Rear wall part
126 Front wall part
128 Knife blade
130 Delivery unit
200 Continuous length of growth medium
210 First side face
220 Second side face
230 First end face
300 Plant growth medium rod
330 First end face
340 Second end face

1. A system for producing a seed and/or fertilizer filled plant growth medium pot, rod or band, comprising:
a supporting means adapted for receiving and supporting a plant growth medium pot, rod, or band;
a feeding tube with a tube lumen the feeding tube adapted for being in a retracted position and in an extended position, wherein the extended position is adapted for insertion into the growth medium of the plant growth medium pot, rod or band;
a delivery unit adapted for delivering a seed and/or a dosage of fertilizer through the feeding tube and into the growth medium;
wherein the feeding tube comprises a cutting means, mounted at the tip of the feeding tube, the cutting means adapted for cutting into the plant growth medium pot, rod or band, thereby facilitating the movement of the feeding tube into the plant growth medium pot, rod, or band.

2. The system according to claim 1, wherein the supporting means comprises an opening or a guide channel adapted for receiving a part of the feeding tube in the feeding tube's extended position.

3. The system according to claim 1, wherein the feeding tube is adapted for being in a closed configuration adapted for holding a seed and/or a dosage of fertilizer within the tube lumen, and in an open configuration adapted for allowing the seed and/or a dosage of fertilizer to escape from the tube lumen.

4. The system according to claim 1, wherein the delivery unit is a drum seeder or a needle seeder.

5. The system according to claim 1, further comprising:
an apparatus adapted for producing a continuous length of growth medium with a first side face, a second side face located opposite to the first side face, and a first end face, wherein the feeding tube is adapted for being inserted into the continuous length of growth medium's first or second side face; and
a cutting apparatus, adapted for separating a part of the continuous length of growth medium comprising the seed and/or dosage of fertilizer to form a seed and/or fertilizer filled plant growth medium pot, rod, or band.

6. The system according to claim 1, further comprising:
a distributor unit adapted for positioning the seed and/or fertilizer filled plant growth medium pot(s), rod(s), or band(s) into an elongated hydroponic reservoir.

7. The system according to claim 6, further comprising a conveyor system adapted for transporting an elongated hydroponic reservoir through the distributor unit.

8. The system according to claim 1, further adapted for delivering a seed and a dosage of fertilizer through the feeding tube at the same time, and formulated as a single unit, such as a pellet.

9. The system according to claim 1, further adapted for delivering a dosage of fertilizer through the feeding tube as one or more pellets.

10. The system according to claim 1, wherein the seed and/or dosage of fertilizer, during the insertion operation, is held on or within the tip of the feeding tube.

11. The system according to claim 10, wherein the seed and/or dosage of fertilizer held on or within the tip of the feeding tube is actively released therefrom by the aid of blowing air through the feeding tube, or by a mechanical push mechanism, such as a piston.
